(19) United States
(12) Patent Application Publication
(10) Pub. No.: US 2012/0052474 A1
(43) Pub. Date: Mar. 1, 2012

(54) Method For Processing Interactive Collaborative Learning For A Group Of People

(76) Inventors: Miguel Nussbaum Voehl, Santiago (CL); Patricio Rodriguez Valdes, Santiago (CL)

(21) Appl. No.: 13/159,268

(22) Filed: Jun. 13, 2011

Related U.S. Application Data
(62) Division of application No. 11/335,814, filed on Jan. 20, 2006, now abandoned.
(60) Provisional application No. 60/649,143, filed on Feb. 3, 2005.

(51) Int. Cl. G09B 5/00

(52) U.S. Cl. 434/350

(57) ABSTRACT

A method for processing interactive collaborative learning for a group of people (class), visually present and a teacher that supervises them. The teacher and each student works with a wired or wireless networked devices. The class is divided in a set of groups that are visually present. The method allows the group members, mediated by their devices, to interact for solving problems and answering questions that can be solved only collaboratively. The role of the networked devices is to present information on each of the participants' electronic display devices, transmit information between the group members, apply the rules of the application stored in each device considering the information of each of the members of the group stored in each of the participants device, and transmit the transactions performed by the group to the teachers device in order to store the group log and display the group outcome at each moment to monitor its progress. The method includes one collaborative way of answering questions and three forms of collaborative problem solving.

### FIELD OF THE INVENTION

This application is a Divisional application of Ser. No. 11/335,814, filed Jan. 20, 2006 which claims the benefit of the filing date of U.S. Provisional Application Ser. No. 60/649,143 filed Feb. 3, 2005, which is incorporated by reference herein.

A collaborative activity can be defined as the commitment of a group of participants in a coordinated effort to reach a specific objective. The interactive collaborative learning for a group of people visually present has the aim of transforming the classroom dynamics from a teacher-centered arrangement, where students are passive, to one enabling collaboration and interaction between students and teacher

A method for processing interactive collaborative learning for a group of people, said method using a computer system to mediate a group of people that interact for solving problems and answering questions. The method includes collaborative ways of answering questions and solving problems.

A computer system is used in the collaborative work to:
Control interactions between the participants.
Provide a space for organizing materials and information.
Coordinate and synchronize the students' activity states.
Mediate the activities and the social interaction of the participants.
Provide the required information to solve the different students' tasks.
Provide the teacher with the currents students' status in order to monitor the activity to allow him/her adequate group mediation.

Additionally the invention comprises a method to automatically recover a working session performed using the computer system if any device malfunctions.

### BACKGROUND OF THE INVENTION

Studies suggest that when students work in groups in a collaborative context, i.e., Collaborative Learning (CL), better academic results are obtained because the students learn more, retain longer what they have learned, develop abilities of superior reasoning and critical thought and feel more valued and confident.

The creation of an effective CL environment depends on the following five key factors:
Individual responsibility: Each member must be responsible for his or her own work, role and effort to learn.
Mutual support: Each member must help to teach other members of the group.
Positive interdependence: The main goal of collaborative activities is the group goal. Therefore, collaboration is considered a success when every member of the group has interacted and has accomplished their individual goal.
Social face-to-face interactions: The decision-making process must include discussions between all collaborators. Productivity is therefore influenced by the ability of the group to efficiently exchange opinions, negotiate and construct an answer together.
Formation of small groups: Communication, discussion and achievement of consensus can be only carried out in small groups, and each member of the group must be physically close to the other members.

The incorporation of technology into Collaborative Learning brings us Computer Supported Collaborative Learning (CSCL) environments in which the technology is used to control interactions between the participants. Technology provides information, regulates tasks, administrates rules and roles, and mediates in the acquisition of new knowledge.

Most CSCL applications are implemented for personal computers and require that the participants be physically located behind the computer screen. Thus, when a CSCL activity is performed within a single space such as a school classroom, these applications do not allow for the development of face-to-face interactions, key factor for obtaining good results in a collaborative work group. By contrast, wirelessly interconnected handheld computers (such as Palm and Pocket PC devices) enable a mobile environment of collaboration to form in a natural manner. Such an environment facilitates face-to-face interactions due to the physical characteristics of the small devices and the mobility that permits the creation of wireless networks.

### SUMMARY OF THE INVENTION

The present invention is related to a method for processing interactive collaborative learning for a group of people who are preferably visually present. The method uses a computer system to mediate a group of people that interact for solving problems and answering questions in a collaborative manner.

The method includes a collaborative way of answering questions and solving problems.

In some embodiments the method for processing interactive collaborative learning applications or activities for a group of people who are preferably visually present and preferably with a teacher supervising them comprises providing wired or wireless networked devices to all members of the class that are visually present; then the group members, mediated by their devices, and/or controlled by the teacher, interact for solving problems or answering questions that can be solved collaboratively.

The group devices transmit the transactions performed by the group to the teacher's device in order to store the group log and display the group outcome at each moment.

Additionally the present invention comprises a method to automatically recover a session from a slave networked device that malfunctioned and a method to automatically recover the master within an active session in which the new master restores the state and the communication with the network that the malfunctioning master already had when the network ID was selected.

### BRIEF DESCRIPTION OF THE DRAWINGS

FIG. 1 is a schematic view of a system for practicing the method;

FIG. 2 is a schematic view of the system of FIG. 1 using multiple choice questions and answers;

FIG. 3 is a schematic view of the system of FIG. 1 wherein members of the student groups receive sets of objects which are exchanged among students in the individual groups until all members of each group agree on the scope between sets of objects;

FIG. 4 is a schematic view of the system of FIG. 1 wherein the students discover the correct sequence of objects received;

FIG. 5 is a schematic view of the system of FIG. 1 wherein the students groups receive the same problem and individual responses are combined in collective decisions, agreed upon, mediated polled and discussed, and

FIG. 6 is a schematic view of the system and method of FIGS. 1 and 5 wherein an activity is solved collaboratively by the interactions of the students.

### DETAILED DESCRIPTION OF THE INVENTION

This invention relates to a method for processing interactive collaborative learning applications or activities for a group of people preferably visually present and optionally with a teacher that supervises them.

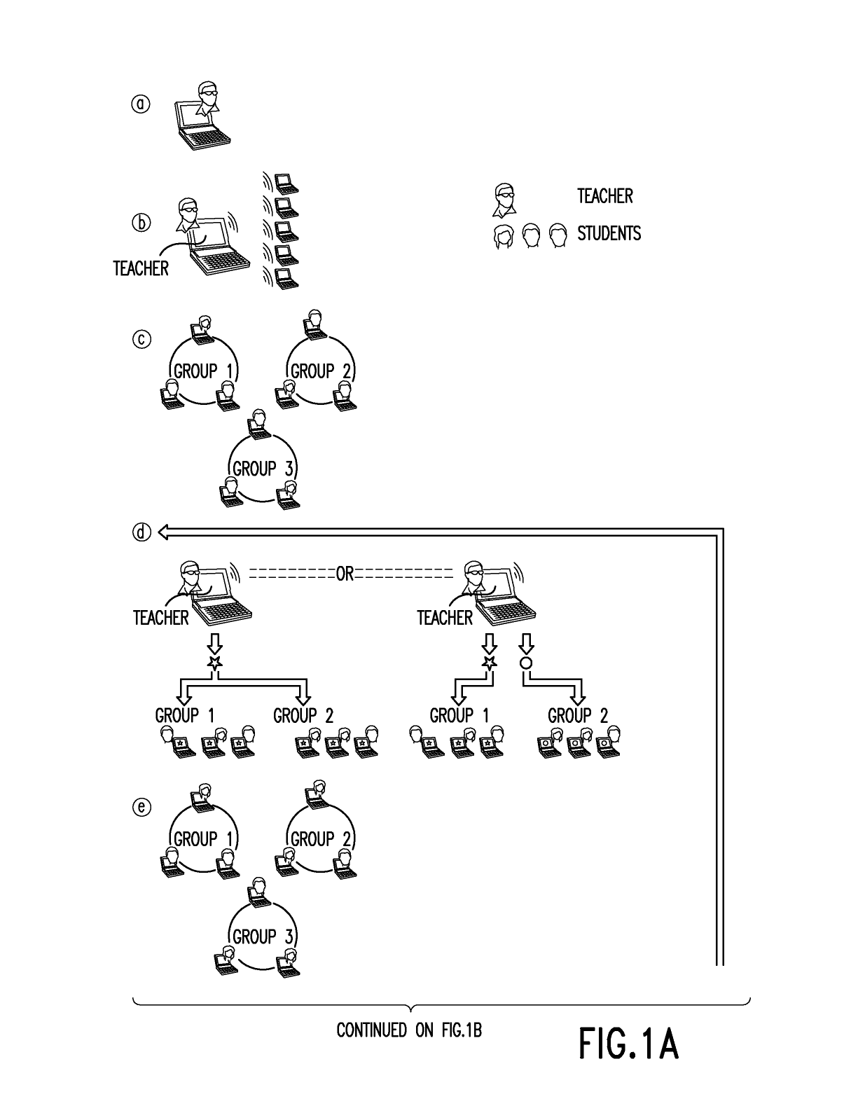

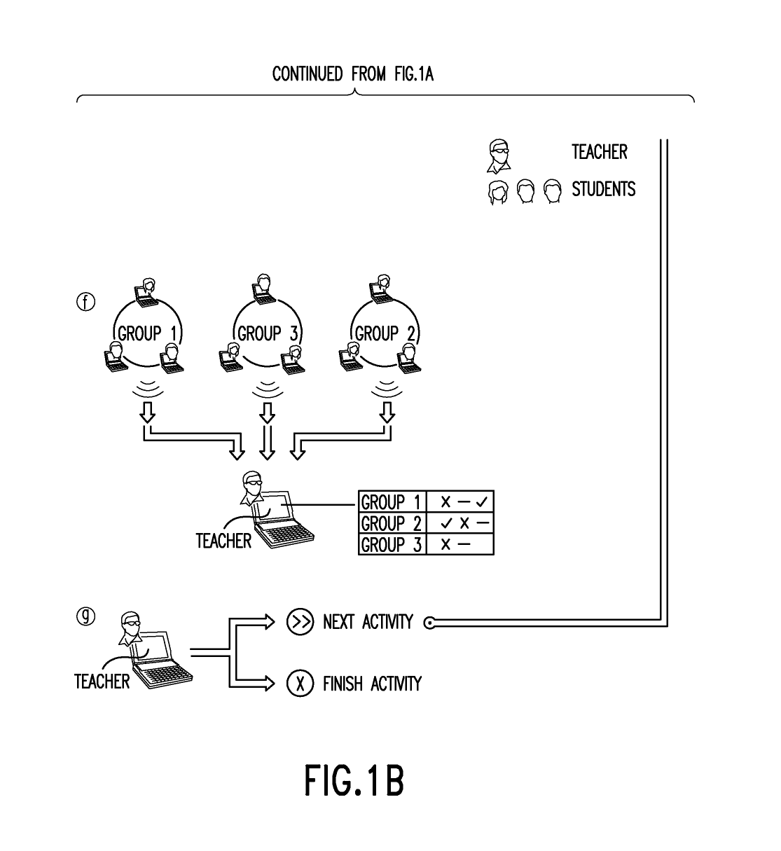

The method comprises the steps of downloading to the master device used preferably by a teacher the application with the corresponding data, wherein said application can be stored preferably in a computer or a web site (FIG. 1a), providing wired or wireless networked devices to all members of the class (FIG. 1b); sending from the master device to the different slave or students' devices a previously selected activity; preferably forming a set of groups with the students of the class (FIGS. 1c and d), wherein the group members, mediated by their devices, and preferably controlled by the teacher, interact for solving problems or answering questions that can be solved collaboratively (FIGS. 1e and f).

The group devices transmit the transactions performed by the group to the master device in order to store the group log and display the group outcome at each moment, and when the teacher finishes the current activity optionally he/she can select another activity and send it to the students, or alternately he/she can terminate the collaborative activity (FIGS. 1g and h).

In accordance with the invention, the applications or activities downloaded to the master device are created, selected and downloaded preferably using a web site, wherein said step of creating the applications or activities comprises selecting and ordering the objects from an existing set in the web site, indicating how the objects selected will interact in the activity from previously existing modes and saving the activity. The steps of selecting and downloading said created activity comprise searching for the activity in the web site; and marking the activity for downloading; then repeating the above steps until all the desired activities are found and marked for downloading. When the teacher commands, only the marked activities are downloaded to the master device, and once the downloading process ends the activities are ready to be used in the master device (FIG. 1a).

In accordance with the method, the step of providing wired or wireless networked devices to all members of the class comprises providing a networked device to each student; the teacher specifying in the master device the class identifier which returns to the device a network ID, preferable related to the selected class; each student logging into his/her networked device using the ID provided by the teacher; the teacher, using the master device, searching and connecting all the available devices that match with the provided ID, thereby creating a network with the students' devices or a session (FIG. 1b).

In the method, the step of sending an activity comprises, after the master device creates a session as is indicated above, the steps of the teacher selecting in the master device a previously downloaded activity (FIG. 1a); the teacher sending the selected activity to all the slave devices that belong to the same session while transmitting and monitoring the progress of the data packages in the master device (FIGS. 1b and f); the teacher starting the activity once the transmission finishes; afterwards, each user logging into his/her slave device thereby identifying himself/herself during the activity by entering an individual ID; and, once the slave devices receive the activity, the devices uncompressing and executing it.

Additionally, in accordance with the invention, the master device can control the work of each group or the whole class (FIG. 1g). The control of each group allows one to run an activity, stop an activity or go to a specific part of the activity. Moreover the master device can create groups of slaves according to the collaboration mode of the activity, which may be specified by the teacher or randomly assigned, and can send the same or different data to each of the groups. The master device can also disband said groups independently or simultaneously.

In some embodiments of the invention the system determines the group composition, indicating in each machine an ID of the group to which it belongs, or alternately the teacher may specify the group composition (FIG. 1c).

Usually the teacher receives in his/her networked device the information of the advancement and outcome of each activity of each group, in order to mediate those groups that need assistance (FIG. 1f).

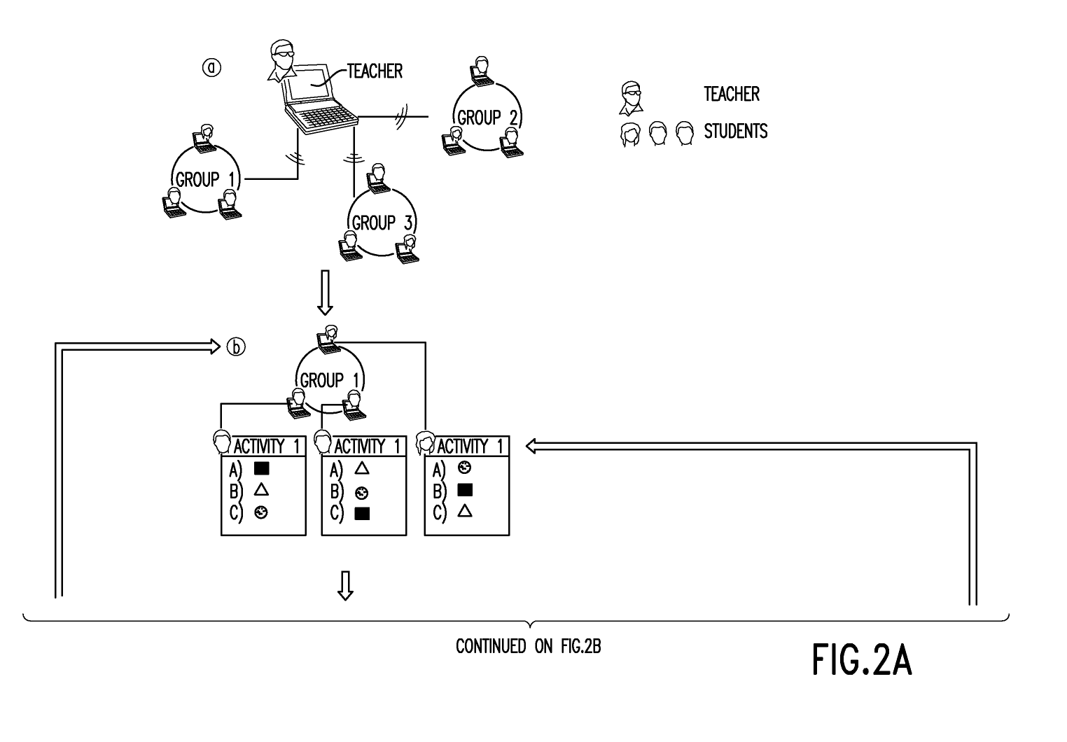

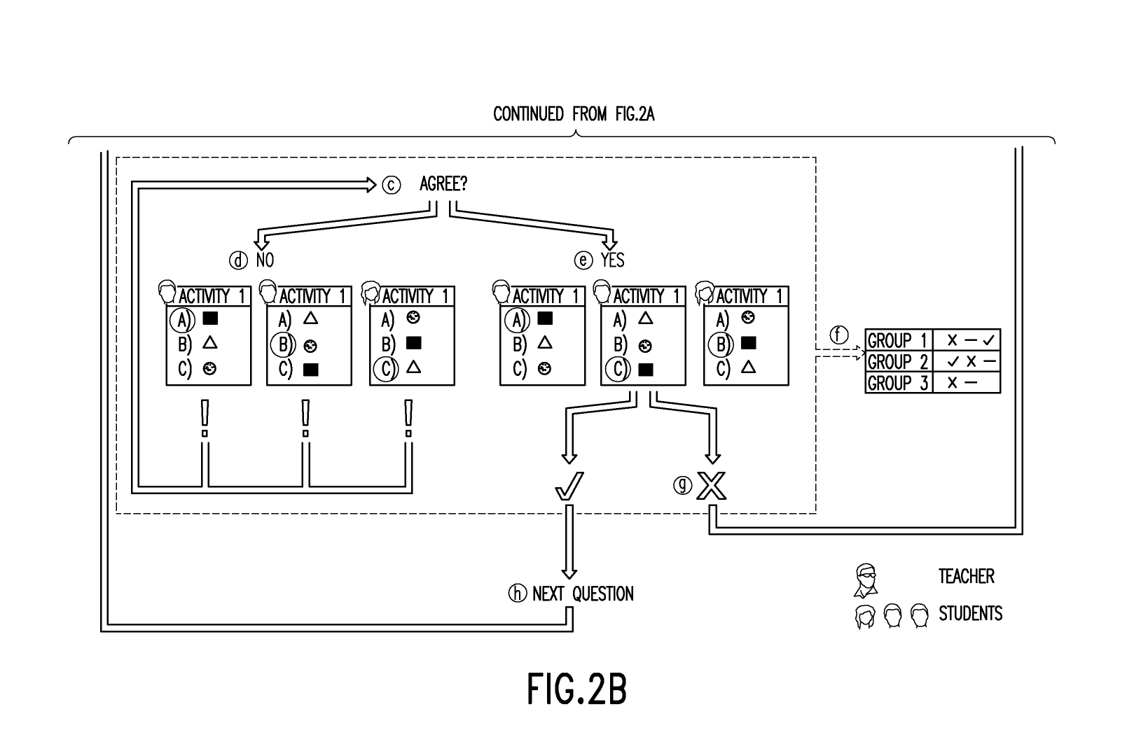

In some embodiments the method for answering multiple-choice questions collaboratively comprises the steps of preferably arranging students in groups, with each student having a slave device which is networked in a session with the other group members and with the master device of the teacher (FIG. 2a); each member of the group receiving the same question with the same multiple answers (FIG. 2b); the members of the group being required to reach a unanimous agreement before answering the question task controlled by the networked devices (FIG. 2c); when the members of a group do not agree on an answer, the networked devices of each member continuing to ask the same question until everyone in the group concurs or after a specified number of iterations (FIG. 2d); once all members of a group agree on an answer, the networked devices validate the answer, thereby informing each member of the group and the teacher if it is right or wrong; and then the teacher receiving in his/her networked device the outcome of each question from each group (FIGS. 2e and f).

Optionally when the group's answer is incorrect, the networked device of each group member informs them of the corresponding error and asks the group to answer the same question, with the previously selected erroneous alternative now preferably excluded, until the correct response is provided. Once all the members of the group select the correct answer, or after a pre-specified number of iterations, the group can then proceed to the next question of the activity (FIG. 2g).

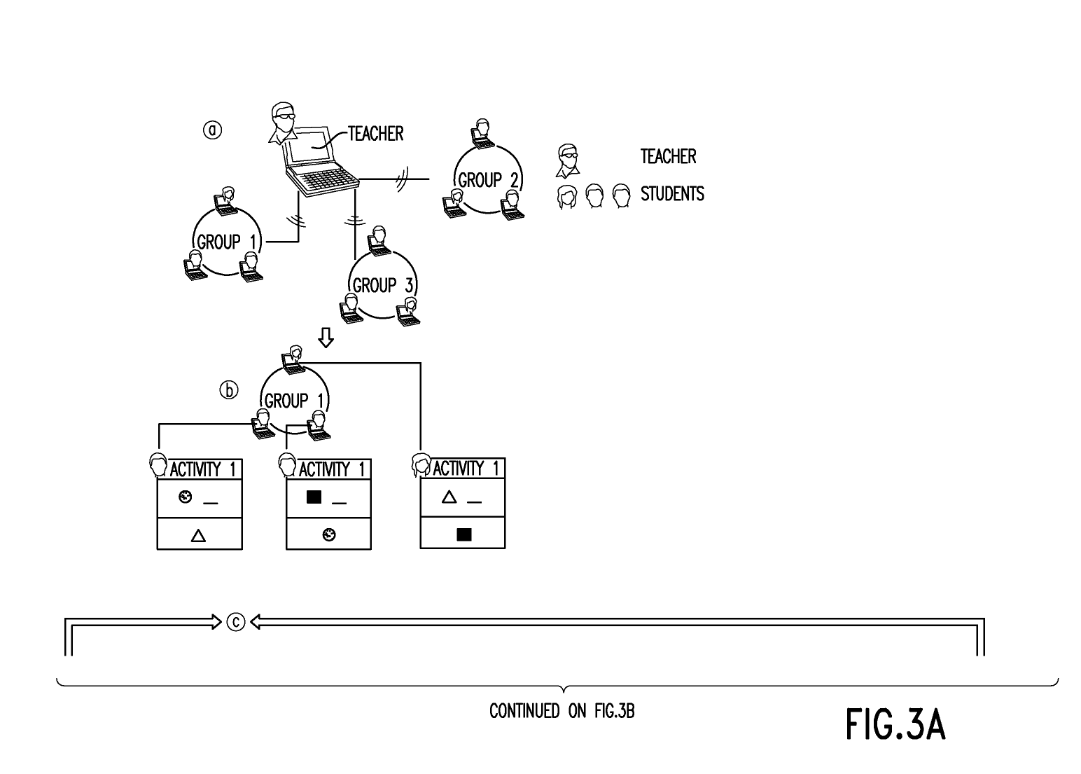

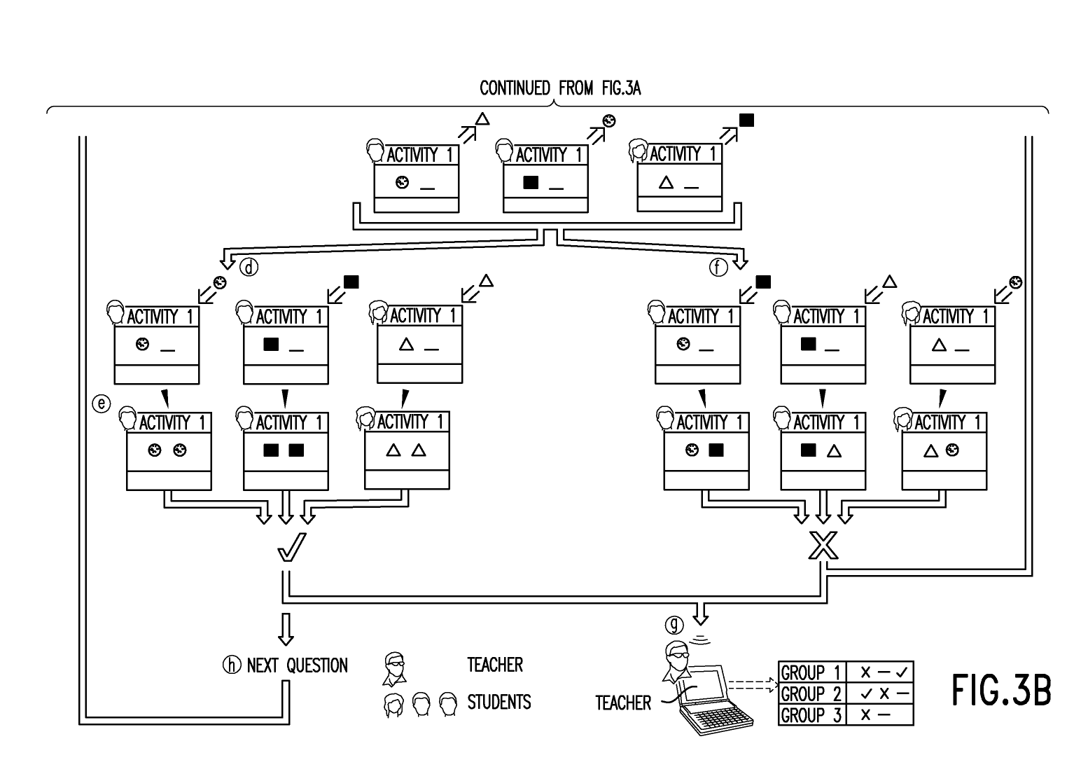

In another preferred embodiment students are preferably arranged in groups, each student having a slave device networked in a session to the devices of other members of the group and to the master device of the teacher (FIG. 3a). Each member of the group receives several sets of objects and a scope between the sets that has to be accomplished (FIG. 3b). The objects belonging to a given set of one group member can be sent to the same set or a different set belonging to another group member, depending on the scope of the activity and only if the receiving group member accepts it (FIG. 3c). The members of the group have to exchange objects until all group members agree that the scope between the sets is accomplished for each of the members (FIG. 3d). Once all group members agree that the scope between the sets of objects has been accomplished, or after a pre-specified number of iterations, the networked devices validate the answer, informing each group member if the scope between the sets has been achieved and also informing the master device (FIG. 3e). When the scope between the sets of objects has not been accomplished for one or more group members, usually the task is repeated (FIG. 3f). When all the members of the group achieve the scope of the activity, or after a pre-specified number of iterations, the group can proceed to the next task (FIG. 3h). The teacher receives in his/her networked device the outcome of the object exchange of each group in order to mediate those groups that need assistance (FIG. 3g).

In some embodiments the scope of the activity is that each member of the group receives two set of objects and a specified logic between both sets that has to be accomplished (FIG. 3b).

In some embodiments the logic of the activity is that one of the sets is questions and the other set is answers. The group members have to interchange answers until each answer of the networked device corresponds to the question of the same networked device (FIGS. 3c, d and e).

In some embodiments the scope of the activity is that one of the sets is preferably one or more goals to achieve and the other set is preferably objects that in combination reach the goal. For example said combination can be any set operation, mathematical operation, or a combination thereof.

In some embodiments the scope of the activity is that one of the sets is preferably one or more goals to achieve and the other set is preferably objects that ordered by physical dimensions in ascending or descending order, or/and numbers or letters that ordered in ascending or descending order, reach the aim.

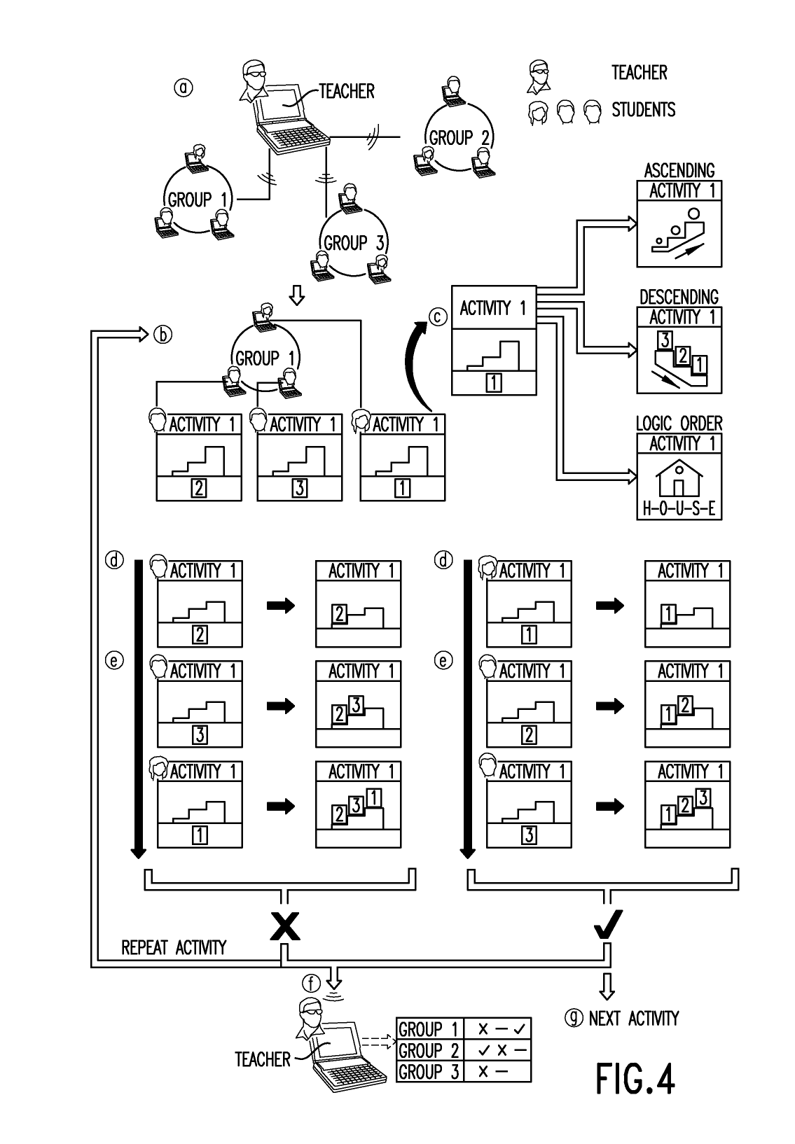

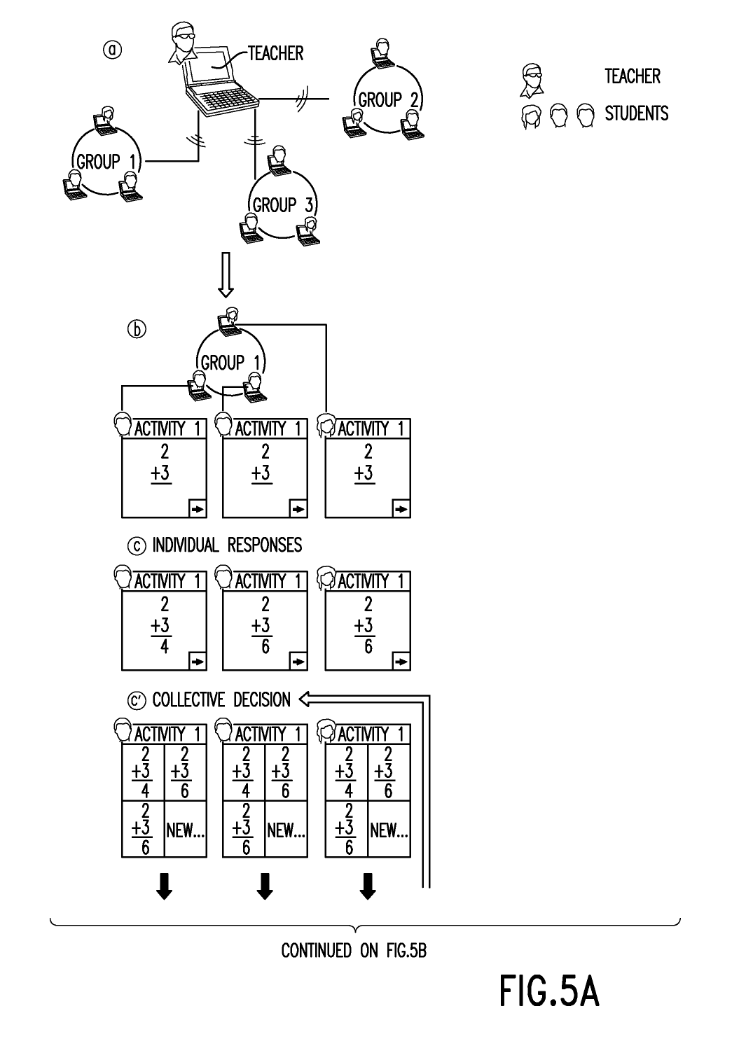

Another preferred embodiment is the method comprising the steps in which students are preferably arranged in groups (FIG. 4a), each student having a slave device networked in a session to the devices of other members of the group and to the master device of the teacher and each group member receives one or more objects (FIG. 4b). The group members have to discover the correct sequence of the objects according to a specific scope provided to them (FIG. 4c). One member of the group selects one of the objects presented in his/her networked device and the selected object is shown to all the members in their networked devices. The above step is repeated by another member of the group until all objects are selected and/or the scope is achieved (FIGS. 4d and e). Afterwards, the networked devices validate the obtained sequence of objects and inform the group members and the teacher, through their respective devices, of whether the obtained sequence achieves the specified scope (FIG. 4f). When the correct sequence of objects is obtained, or after a pre-specified number of iterations in which the group tries again to solve the unsolved quiz, the group can proceed to the next task (FIG. 4g).

In accordance with the previous embodiment the scope of the activity is for example order sets of numbers in ascending or descending order, construct words from syllabus, construct geometrical or another graphical object from components, or order objects according to physical dimensions in ascending or descending order (FIG. 4c).

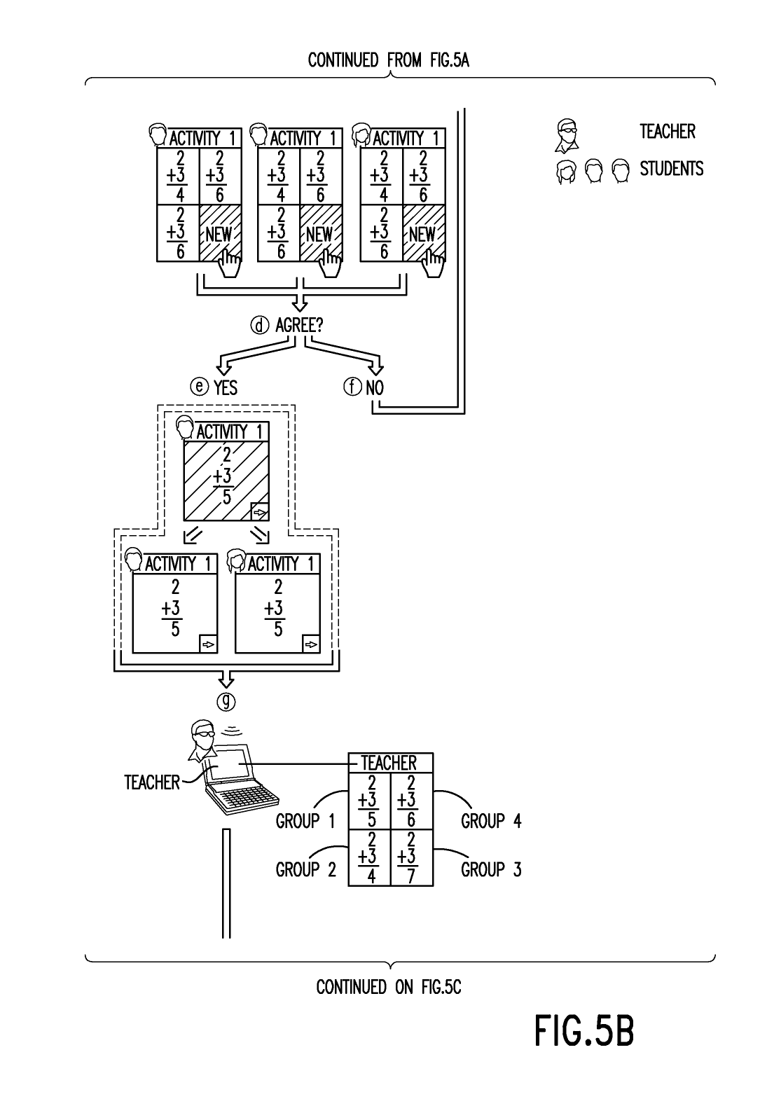

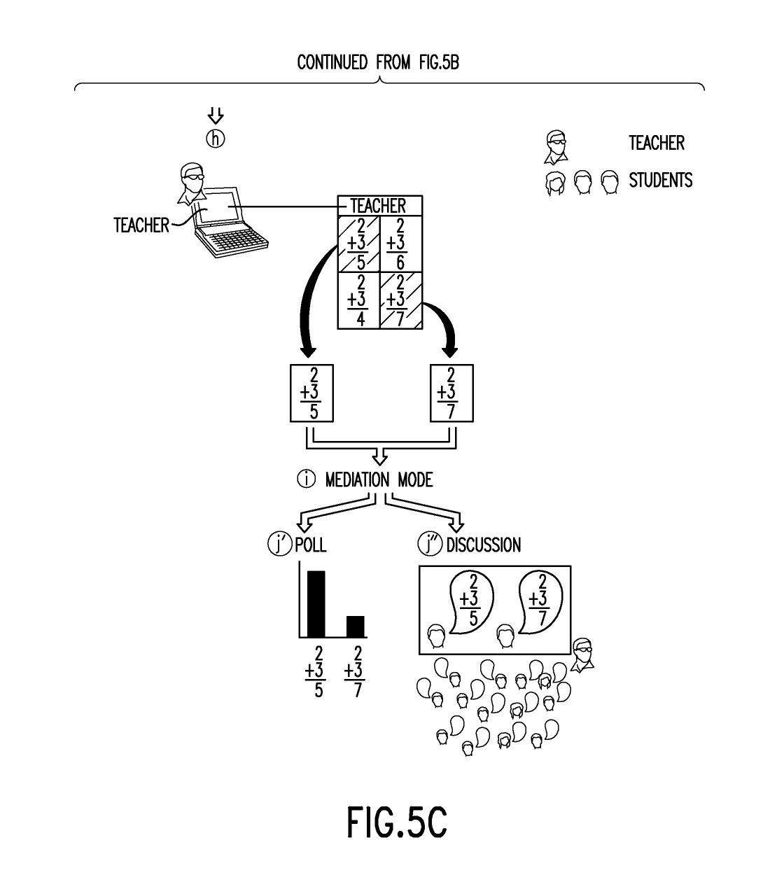

Another preferred embodiment is the method comprising the following steps: students are preferably arranged in groups, each with a slave device networked in a session to the devices of other members of the group and to the master device of the teacher (FIG. 5a); the teacher sends to all the students the same problem to solve (FIG. 5b); the students write their solution on the screen of their networked devices or use the built in simulator of the networked device to solve the problem (FIG. 5c); then the group members have to reach an unanimous agreement on which is the right response from among the answers they have wrote on the screens or obtained with their simulators of their networked devices, before replying to the teacher (FIG. 5c′). If all of them agree on an answer, the agreed answer is sent to the teacher (FIGS. 5d and e). If they all agree upon an answer that is different than the one that each member developed independently, then one group member is selected randomly by the device network to submit the group answer by writing it down on his/her screen or use the built in simulator of the networked device to obtain the group answer; the group answer is then sent to the teacher's device (FIGS. 5f and g). Once the teacher receives all group answers she/he can optionally select a set of answers to be discussed by the class (FIG. 5h). In accordance with the above embodiments, the discussion mode between teacher and students consists of the teacher polling preferably a subset of the answers sent by the students. After the poll, the teacher can randomly select (action performed by the networked devices of the group) a student to endorse his/her vote in front of the class to generate a class discussion (FIG. 5i).

Alternatively the discussion mode between teacher and students consists of randomly selecting one of the students from the group that sent a given answer (action done by the networked devices of the group) (FIG. 5h) to support his/her reply in front of the class to provoke a class discussion (FIG. 5i).

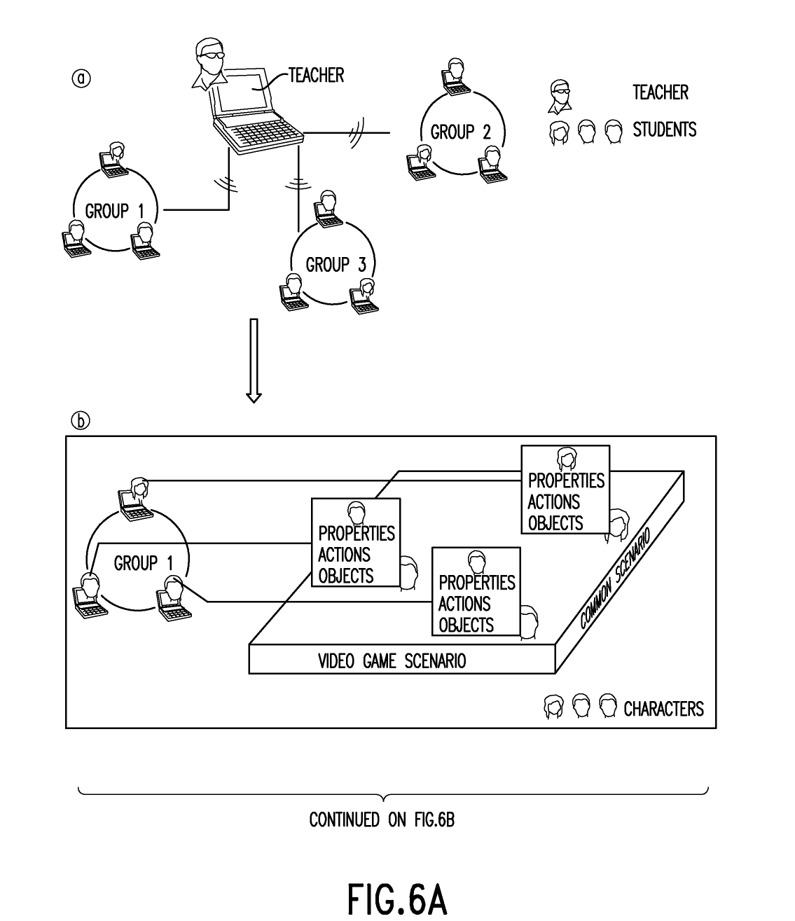

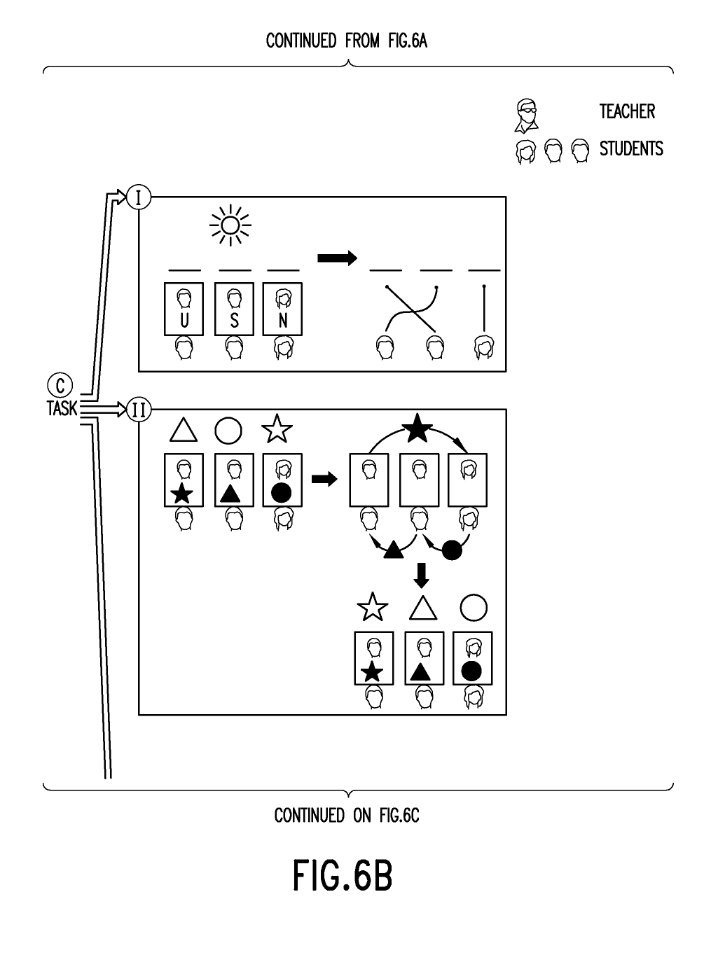

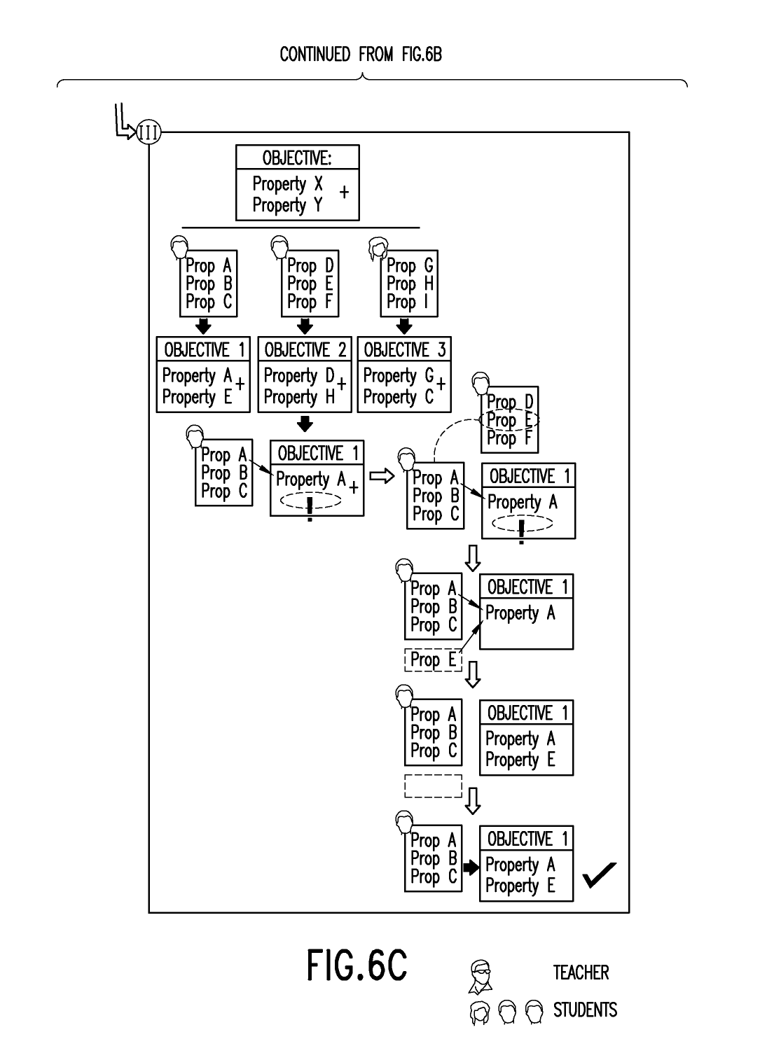

Another preferred embodiment is the method comprising the following steps: students are preferably arranged in groups, each with a slave device networked in a session to the devices of other members of the group and to the master device of the teacher; the teacher sends to all the students an activity in which every member of the group has a specific role allowing him/her to interact with his/her partners in the group, The task of the activity has to be solved collaboratively by the interactions of the members of the group, which perform actions which are transmitted to the other members of the group (FIG. 6—Classroom).

In accordance with the previous embodiment, the activity can be a videogame, where each member of the group commands an assigned character with specific features and roles and the exchanged information between members of the group are the actions of each character which are reflected in each screen of the devices of the group (FIG. 6—Background).

In accordance with the invention, usually the display of online transactions in the master device is done through a matrix. The matrix rows correspond to the different group that are performing the activity, and the columns correspond to the coded answers to each task, or alternately the matrix columns correspond to the different groups that are performing the activity, and the rows correspond to the coded answers to each task. Said code is done with symbols, for example symbol 1 if the group solves the scope correctly at the first try, symbol 2 if the number of trials are between 2 and ┌n/2┐ (n being the pre-specified number of iterations) and symbol 3 if the number of trials are between ┌n/2+1┐ and n. Unanswered questions are, for example, codified with symbol 4. If the scope were not solved within the pre-specified number of iterations these questions are also codified with symbol 4 (FIG. 2f, FIG. 3g and FIG. 4f).

Said symbols are, for example, the following: symbol 1 is a green colored rectangle, symbol 2 is a yellow colored rectangle, symbol 3 is a red colored rectangle and symbol 4 is a grey colored rectangle.

In accordance with the invention the pre-specified number of iterations in which group members must correctly answer a question is predetermined in the software or by the teacher in his/her master device for each specified group or for all groups simultaneously.

Another aspect of the invention is the role of the networked devices in the method, said role comprising: to present information on each of the participants' electronic display devices, to transmit information between the group members, to apply the rules of the application stored in each device considering the information of each of the members of the group stored in each of the participants device, and to transmit the transactions performed by the group to the teacher's device in order to store the group log and display the group outcome at each moment to monitor its progress.

Another aspect of the invention is a method for connection of a slave to the master after an activity has started or is in execution, said method comprising the following steps: the student logs into his/her networked device with the ID provided by the teacher that corresponds to the same ID used by all other devices on the same network; then the master networked device, automatically and without teacher intervention, sends the current activity and the corresponding state belonging to the new slave, incorporating it into the groups according to the rules of the activity.

The present invention is also related with a method to automatically recover a session from a slave networked device that malfunctions, loses data or loses its connection with the master, said method comprising the following steps: the master and slaves devices will try to reestablish the previously existing connection automatically; when the previous step fails, or the networked device(s) malfunctions, the networked device(s) have to be reset; and after being reset the network ID and the individual ID are entered into the networked device(s).

Another aspect of the invention is a method to automatically recover the master within an active session. The new master restores the state and the communication with the network that the malfunctioning master previously had when the network ID was selected.

The present invention is also related with a method to automatically update the slave and master devices with a new version of the system, downloaded preferably from the website, and a new version of the activities created using preferably the website, said method comprising the following steps: synchronizing the master with the website; then downloading a new version of the system and/or activities; once downloaded automatically, installing the new version in the master; and the master updating the slaves in the next session.

Having described some embodiments of the invention, one with ordinary skill in the art will now realize further features and advantages of the invention from the above described embodiments. It should be understood, therefore, that the foregoing is only illustrative of the principles of the invention and that various modifications can be made by those skilled in the art without departing from the scope and spirit of the invention. Accordingly, the invention is not to be limited by the above description.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding U.S. Provisional Application Ser. No. 60/649,143, filed Feb. 3, 2005, are incorporated by reference herein.

The preceding examples can be repeated with similar success by substituting the generically or specifically described reactants and/or operating conditions of this invention for those used in the preceding examples. In the foregoing and in the examples, all temperatures are set forth uncorrected in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1-27. (canceled)

28. A method for processing interactive computer supported collaborative learning activities for a group of people visually present with each other in a class including a teacher that supervises them, the method using a computer system which operates to control interactions between participants, the computer system providing the required information to solve tasks and coordinating, synchronizing and mediating the activities, the computer system including wired or wireless networked devices to all members of the class, the networked devices operating to display information on each of the participants' electronic display devices, transmit the information between the group members, apply applied rules, transmit transactions performed by the group to the teacher's device and display group outcome at each moment to monitor the groups progress;
wherein said method includes a method for answering multiple-choice questions collaboratively on group member's networked devices and comprises the following steps:
a) arranging students in groups, with each student having a student device networked in a session to the other members of the group and to the teacher device;
b) each member of the group receiving the same question with the same multiple options from the activity stored in their networked devices, but not necessarily ordered in the same way;
c) the members of the group being required to reach a unanimous agreement before answering the question;
d) if the members of a group do not agree on an answer, the networked device of each member repeatedly asking the same question until everyone in the group concurs;
e) once all members of a group agree on an answer, the networked device of each member validating the answer, and then informing the members and the teacher if the answer is right or wrong;
f) the teacher receiving the information of the outcome of each question of each group in his/her networked device;
g) if the answer of a group is incorrect, the networked device of each group member informing the corresponding error and asking the group to answer the same question, with the previously selected erroneous alternative now excluded, until a correct response is achieved;
h) once all the members of the group select the correct answer, or after a pre-specified number of iterations, the group then proceeding to the next question, where a pre-specified number of iterations is predetermined: I) in the software; or II) by the teacher in the networked device for each specified group or for all groups simultaneously.

29. The method according to claim 28, wherein the display of online transactions is done through a matrix, wherein the matrix rows correspond to the groups created for running the activity, and wherein the columns correspond to the tasks answers that are coded; otherwise, the matrix columns correspond to the groups created for running the activity, and the rows correspond to the tasks answers that are coded, where said code is represented by the following symbols: symbol 1 if the group solves the scope correctly on the first try, symbol 2 if the number of trials are between 2 and [n/2], n being the pre-specified number of iterations, and symbol 3 if the number of trials are between [n/2+1] and n, wherein unanswered questions are codified with symbol 4 and if the scope is not solved within the pre-specified number of iterations the answer is also marked with symbol 4.

30. A method for processing interactive computer supported collaborative learning activities for a group of people visually present with each other in a class including a teacher that supervises them, the method using a computer system which operates to control interactions between participants, providing the required information to solve tasks and coordinating, synchronizing and mediating the activities, the computer system including a wired or wireless networked devices to all members of the class, the networked devices operating to show information on each of the participants' electronic display devices, transmit the information between the group members, apply applied rules, transmit the transactions performed by the group to the teacher's device and display group outcomes at each moment to monitor the groups progress;
wherein said method includes a method for interchanging objects between group members, and comprises the following steps:
a) arranging students in groups, with each student having a student device networked in a session to the other members of the group and to the teacher device;
b) the system defining a logic which relates two sets of objects;
c) each member of the group receiving the two sets of objects and specified logic between both sets that has to be accomplished;
d) the members of the groups interchanging objects until all group members agree that the aim between the sets is accomplished for each of the members;
e) once all group members agree that the aim between the sets of objects is accomplished, the system validating the answer, then informing to each group member device and to the teacher's device if the aim between the sets has been achieved;
f) if the scope between the sets of objects has not been accomplished, for one or more group members, repeating the task;
g) the teacher receiving the information of the outcome of object interchange of each group in his/her teaching device;
h) when all the members of the group achieve the aim of the activity, or after a number of pre-specified iterations, the group proceeding to the next activity, said pre-specified number of iterations being predetermined: I) in the software; or II) by the teacher in his/her networked device for each specified group or for all groups simultaneously.

31. The method claim 30, wherein the display of online transactions is done through a matrix, wherein the matrix rows correspond to the groups created for running the activity, and wherein the columns correspond to the tasks answers that are coded; otherwise, the matrix columns correspond to the groups created for running the activity, and the rows correspond to the tasks answers that are coded, where said code is represented by the following symbols: symbol 1 if the group solves the scope correctly on the first try, symbol 2 if the number of trials are between 2 and [n/2], n being the pre-specified number of iterations, and symbol 3 if the number of trials are between [n/2+1] and n, wherein unanswered questions are codified with symbol 4 and if the scope is not solved within the pre-specified number of iterations the answer is also marked with symbol 4.

32. A method for processing interactive computer supported collaborative learning activities for a group of people visually present with each other in a class including a teacher that supervises them, the method using a computer system which operates to control interactions between participants, the computer providing the required information to solve tasks and coordinating, synchronizing and mediating the activities, the computer system including wired or wireless networked devices to all members of the class, the networked devices operating to display information on each of the participants' electronic display devices, transmit the information between the group members, apply applied rules, transmit transactions performed by the group to the teachers device and display the group outcome at each moment to monitor the groups progress;
wherein said method includes a method for ordering objects between group members and comprises the following steps:
a) arranging students in groups, with each student having a student device networked in a session to the other members of the group and to the teacher's device;
b) each group member receives one or several objects;
c) the group members being required to find out the correct sequence according to a given logic aim given to all group members; the scope of the activity being to order sets of objects in ascending, descending order or a given logic order;
d) one member, whose turn comes according to the logic, selecting one of the objects shown in the member's networked device, where the selected object corresponds to the logic order and once said object is selected the object is part of the answer and sent to the networked devices of all the members of the group;
e) repeating the previous step d) by another member of the group, whose turn comes according to the logic, until the pre-specified logic is achieved;
f) afterwards, the system validating the obtained sequence of objects and informing the group members and the teacher through their respective networked devices if the obtained sequence achieves a specified logic aim;
g) when all the correct sequence of objects is obtained or after a number of pre-specified iterations, the group proceeding to the next activity, said pre-specified number of iterations being predetermined: I) in the software; or II) by the teacher in his/her networked device for each specified group or for all groups simultaneously.

33. The method according to claim 32, wherein the display of online transactions is done through a matrix, wherein matrix rows correspond to the groups created for running the activity, and wherein columns correspond to the tasks answers that are coded; otherwise, the matrix columns correspond to the groups created for running the activity, and the rows correspond to the tasks answers that are coded, where said code is represented by the following symbols: symbol 1 if the group solves the scope correctly on the first try, symbol 2 if the number of trials are between 2 and [n/2], n being the pre-specified number of iterations, and symbol 3 if the number of trials are between [n/2+1] and n, wherein unanswered questions are codified with symbol 4 and if the scope is not solved within the pre-specified number of iterations the answer is also marked with symbol 4.

34. A method for processing interactive computer supported collaborative learning activities for a group of people visually present with each other in a class including a teacher that supervises them, the method using a computer system which operates to control interactions between participants, the computer providing the required information to solve tasks and coordinating, synchronizing and mediating the activities, the computer system including a wired or wireless networked devices to all members of the class, the networked devices operating to display information on each of the participants' electronic display devices, transmit the information between the group members, apply applied rules, transmit transactions performed by the group to the teachers device and display group outcome at each moment to monitor the groups progress;
wherein said method includes a method for answering questions or solving problems collaboratively and comprises the following steps:
a) arranging students in groups, with each student having a student device networked in a session to the other members of the group and to the teacher device;
b) the teacher sending to all the students a question with open answer;
c) the students writing down their own answers on their networked devices and the system sharing their answers with the others members of the group; these answers becoming the eligible options to the problem;
d) if the group members reach a unanimous agreement on which is the right response among the answers they have provided, the students sending the reply to the teacher;
e) if all the group members agree that none of the available options is an adequate answer, the group members selecting the option to create a new group answer and the system consequently selecting one of the students in the group, the other members having to agree either to accept or reject the answer written by the selected student;
f) if the team members do not agree on the answer, the step e) has being repeated until an agreement is reached;
g) once the agreement is reached, the team members sending the group answer to the teacher's device;
h) once the teacher's device receives all group answers, the teacher using the teacher's device to select a sub-set of answers to be discussed by the class;
i) the teacher shares with all the students the selected answers, and starts a discussion mode between teacher and students, said discussion mode being either : I) the teacher polls the students of the selected answers and after the poll, the teacher randomly selects a student to endorse the vote before of the class to bring out a discussion; or II) the system randomly selects one of the students from the group that sent the selected answer in order to support the reply and provokes a discussion in the class.

35. The method according to claim 34, wherein the display of online transactions is done through a matrix where the matrix rows correspond to the groups created for running the activity, and the respective columns correspond to the state of the answering process; otherwise, the respective matrix columns correspond to the groups created for running the activity, and the corresponding matrix rows correspond to the state of the answering process.

36. A method for processing interactive computer supported collaborative learning activities for a group of people visually present with each other in a class including a teacher that supervises them, the method using a computer system which operates to control interactions between participants, the computer system providing the required information to solve tasks and coordinating, synchronizing and mediating the activities, the computer system including a wired or wireless networked devices to all members of the class, the networked devices operating to display information on each of the participants' electronic display devices, transmit the information between the group members, apply applied rules, transmit the transactions performed by the group to the teacher's device and display the group outcome at each moment to monitor the groups progress;
wherein said method includes a method wherein the information to show to each of the participants from the teacher device is a scenario from a video game, and comprises the following steps:
a) arranging students in groups, with each student having a student device networked in a session to the other members of the group and to the teacher device;
b) the teacher sending to all the students an activity in which each group member commands an assigned character on his/her student device, said assigned character defining his/her specific role for the interaction with the other members of the group;
c) the system defining the game in the form of tasks and constraints that must be fulfilled by the members of a group, wherein the tasks are: I) objects of the game that have to be sequentially fulfilled by the members of the group following a predefined logic; II) a group member optionally assisting another member of the same group using his/her own role, in order to reach an object and accomplish the group goal according to a predefined logic; III) objects of the game being selected by the members of the group to fulfill a predefined logic, having to be shown to all the members in their networked devices as part of the answer; and wherein the constraints are: I) coordinated actions between the members of the group that have to be fulfilled, following a predefined logic; II) roles that the members of the group have to fulfill, following a predefined logic; and III) ambiance conditions that follow a predefined collaborative logic;
d) the members of the group having to interact and collaborate to solve the task;
e) when all the objects of the game are correctly fulfilled according to a predefined logic or after a number of pre-specified iterations, the group proceeding to the next activity, said pre-specified number of iterations being predetermined: I) in the software; or II) by the teacher in his/her networked device for each specified group or for all groups simultaneously.

37. The method according to claim 36, wherein the display of online transactions is done through a matrix, wherein the matrix rows correspond to the groups created for running the activity, and wherein the columns correspond to the task answers that are coded; otherwise, the matrix columns being corresponding to the groups created for running the activity, with the rows correspond to the task answers that are coded, where said code is represented by the following symbols: symbol 1 if the group solves the scope correctly on the first try, symbol 2 if the number of trials are between 2 and [n/2], n being the pre-specified number of iterations, and symbol 3 if the number of trials are between [n/2+1] and n, wherein unanswered questions are codified with symbol 4 and if the scope is not solved within the pre-specified number of iterations the answer is also marked with symbol 4.
